(19) United States
(12) Patent Application Publication
(10) Pub. No.: US 2002/0188385 A1
(43) Pub. Date: Dec. 12, 2002

(54) Method and system for delivery of data that are relevant for aviation to databases

(76) Inventor: Werner Dietmuller, Sinzheim (DE)

Correspondence Address: COLLARD & ROE, P.C., 1077 Northern Boulevard, Roslyn, NY, 11576-1696, US

(21) Appl. No.: 10/132,881

(22) Filed: Apr. 25, 2002

(30) Foreign Application Priority Data
Apr. 25, 2001 (DE) 101 20 370.5

(51) Int. Cl. G01C 21/00

(52) U.S. Cl. 701/4; 701/213

(57) ABSTRACT

A method is provided for delivery of data that are relevant for aviation to databases in navigation instruments in aircraft comprising a computing and memory unit together with a display unit. The data are communicated from a service provider as the transmitter via GSM modules (5) of a radiotelephone operator to the computing and memory unit (1) of the navigation instrument. An arrangement for performing the method is also provided wherein the computing and memory unit (1) of the navigation instrument in the aircraft is arranged in the aircraft with a GSM module (5) with an antenna (12) that is standard in radiotelephone technology and with corresponding GSM access to the data transmitter.

### CROSS REFERENCE TO RELATED APPLICATIONS

Applicant claims priority under 35 U.S.C. §119 of German Application No. 101 20 370.5 filed Apr. 25, 2001.

### BACKGROUND OF THE INVENTION

1. Field of the Invention

The present invention relates to a method for delivery of data that are relevant for aviation to databases in navigation instruments in aircraft including a computing and memory unit together with a display unit. The invention also relates to a system for performing this method.

2. The Prior Art

For navigation during flight there are needed databases, which have been updated heretofore by various service providers via data media. Normally, the data media have been mailed to the operator, so that they can then be made available in the aircraft. This process is time-consuming and susceptible to error.

Systems for data transmission and delivery are also known. Unfortunately, they necessitate special, expensive, complex (Gatelink for airliners) and wireless (via special data radio or satellite communication) infrastructures, which are not suitable for general aviation.

### SUMMARY OF THE INVENTION

The object of the present invention is to provide a method for delivery of relevant aviation data to navigation databases in aircraft, in which the process of delivery of the data takes place automatically, with the additional benefit that the current flying weather and flight plans can be communicated.

In accordance with the invention, a method is provided for delivery of data that are relevant for aviation to databases in navigation instruments in aircraft including a computing and memory unit together with a display unit. The data are communicated from a service provider as the transmitter via GSM modules of a radio-telephone operator to the computing and memory unit of the navigation instrument.

After the system has been activated on the ground, a check is run by the system to determine whether the database and other data have been updated to the most recent status and whether data records may have to be corrected, deleted or supplemented.

Preferably, the method can be performed by an arrangement where the computing and memory unit of the navigation instrument in the aircraft is arranged with a GSM module with an antenna that is standard in radiotelephone technology and with corresponding access to the data transmitter. Alternatively, the computing and memory unit of the navigation instrument in the aircraft is arranged with a CDPD module with an antenna that is standard in radiotelephone technology and with corresponding access to the data transmitter.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a block diagram of an arrangement according to an embodiment of the invention; and

FIG. 2 is an exploded view of the housing of an instrument for the arrangement according to the invention.

### DETAILED DESCRIPTION OF PREFERRED EMBODIMENTS

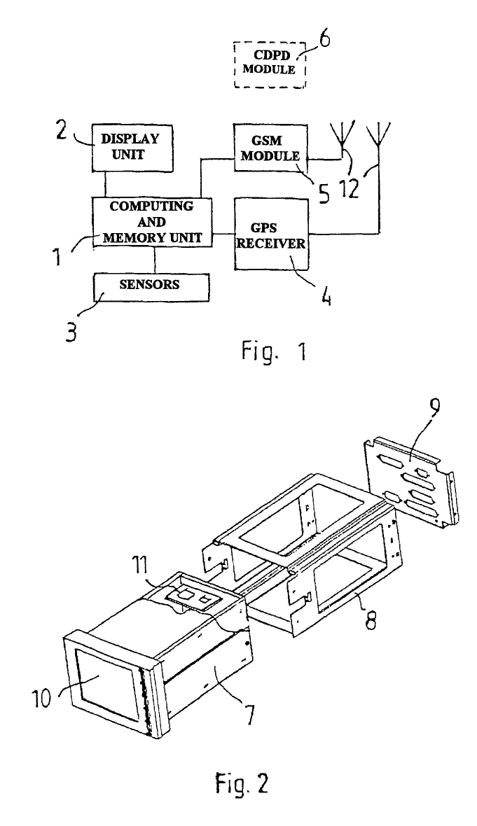

Referring now in detail to the drawings and, in particular, FIG. 1 is a block diagram showing the central unit of the navigation system which comprises a computing and memory unit 1 connected to a display unit 2, such as a monitor. In addition, sensors 3 can be connected to computing and memory unit 1. Computing and memory unit 1 is normally connected to at least one GPS receiver 4, which represents a navigation unit and provides location information to display unit 2.

According to the invention, there is now integrated a GSM module 5 such as is known from radiotelephone systems. This module permits reception of SMS or the establishment of data and voice communications.

The current position can be displayed on digital maps by means of appropriate software. For navigation, positions that determine course and direction and that are relevant for aviation (airfields, navigation installations, way points) can also be displayed. These databases that are relevant for aviation must be regularly updated to the most recent status, which is accomplished by means of the connected GSM module. The method according to the invention then takes place as follows.

After the system has been activated in the aircraft while it is still on the ground, the system logs on to the service provider. Thereafter a check is run by the service provider to determine whether the database and other data have been updated to the most recent status. If necessary, data records are corrected, deleted or supplemented. If a flight has been planned with another computer or in the Internet before activation, the corresponding flight plan will be transmitted. In the process, current data such as weather and Notam can also be loaded.

A particular software routine can be readily created, which checks for data integrity and optimized use of the data channel.

After the flight, the takeoff and touchdown times will also be briefly transmitted and, if the on-board instrumentation has such capability, the data on the weather through which the flight has passed will also be transmitted, in order then to communicate precise weather predictions to other users.

In a further embodiment, GSM module 5 in FIG. 1 can be replaced by a CDPD module with an antenna that is standard in radiotelephone technology and with corresponding CDPD access 6 to the data transmitter. CDPD modules are widely used in the USA, for example. Thereby a service that is also based on the cellular telephone system can again be employed.

FIG. 2 illustrates a housing 7 with a holder 8 and a back wall 9. Housing 7 is provided at the front end with a monitor 10. The housing is shown in a partly cutaway view, so that module 11, which corresponds to the block diagram of FIG. 1, is visible in its position at the rear corner. This module is connected to an antenna 12, illustrated in FIG. 1, of the radiotelephone system.

Accordingly, while only two embodiments of the present invention have been shown and described, it is apparent that many changes and modifications may be made thereunto without departing from the spirit and scope of the invention.

What is claimed is:

1. A method for delivery of data relevant for aviation to databases in a navigation system in an aircraft comprising a computing and memory unit connected to at least one GPS receiver, and a display unit, which comprises the steps of:
(a) communicating data relevant for aviation from a service provider via at least one data transmitter selected from the group consisting of a GSM module and a CDPD module to the computing and memory unit of the navigation system; and
(b) running a check after the navigation system has been activated to determine whether the database and other data have been updated with the most recent status information and whether the database and other data need to be corrected, deleted or supplemented.

2. A method according to claim 1, wherein the data relevant to aviation comprises information selected from the group consisting of airfields information, navigation installations information, way points information and weather information.

3. A system for delivery of data relevant for aviation to databases in a navigation system in an aircraft comprising:
(a) a computing and memory unit;
(b) at least one GPS receiver connected to said computing and memory unit;
(c) a display unit connected to said computing and memory unit; and
(d) a GSM module connected to the computing and memory unit having an antenna for GSM access to a data transmitter.

4. A system for delivery of data relevant for aviation to databases in a navigation systems in an aircraft comprising:
(a) a computing and memory unit;
(b) at least one GPS receiver connected to said computing and memory unit;
(c) a display unit connected to said computing and memory unit; and
(d) a CDPD module connected to the computing and memory unit having an antenna for CDPD access to a data transmitter.
